(19) United States
(12) Patent Application Publication
(10) Pub. No.: US 2007/0081137 A1
(43) Pub. Date: Apr. 12, 2007

(54) Exposure method

(76) Inventor: Chun-Yu Lin, Kaohsiung City (TW)

Correspondence Address: J.C. Patents, Inc., 4 Venture, Suite 250, Irvine, CA, 92618, US

(21) Appl. No.: 11/302,746

(22) Filed: Dec. 13, 2005

(30) Foreign Application Priority Data
Oct. 6, 2005 (TW) 94134927

(51) Int. Cl. G03B 27/52

(52) U.S. Cl. 355/55; 355/53

(57) ABSTRACT

An exposure method is suitable for an off-axis illumination system. According to the method, a photomask having a first pattern and a second pattern is provided, and an analysis on the photomask is conducted to obtain a first light source intensity distribution corresponding to the first pattern and a second light source intensity distribution corresponding to the second pattern. The light source of the off-axis illumination system is adjusted to have the first light source intensity distribution for conducting exposure on the first pattern of the photomask, followed by adjusting the light source to have the second light source intensity distribution for conducting exposure on the second pattern of the photomask.

### CROSS-REFERENCE TO RELATED APPLICATION

This application claims the priority benefit of Taiwan application Ser. No. 94134927, filed on Oct. 06, 2005. All disclosure of the Taiwan application is incorporated herein by reference.

### BACKGROUND OF THE INVENTION

1. Field of Invention

The present invention relates to an exposure method, and particularly to an exposure method suitable for an off-axis illumination system.

2. Description of the Related Art

The photolithography process is one of the most significant processes in integrated circuit (IC) manufacturing. Due to the constantly downsized trend of ICs, the photolithography technique faces an obstacle in the high-integration processes. Accordingly, various lithography techniques are developed, such as X-ray lithography and electron beam lithography (EB lithography). However, by means of the persistent improvements the photolithography technique still is the most important one in all lithography techniques.

To improve the photolithography technique, some measures targeting for advancing the exposure equipment, the photomask and the photoresist material can be taken. For pursuing the resolution enhancement, the above-mentioned improvement efforts encounter many physical restrictions, for example, the common diffraction problem. To easy the diffraction problem, in terms of an illumination system in an exposure equipment, for example, a so-called off-axis illumination system was provided.

In an off-axis illumination system, apertures are disposed at the light source thereof and the aperture disposition must be designed against various photomasks for providing the optimum light source intensity distribution. For example, the photomask pattern in FIG. 1A is suitable for the disposition of the apertures 102 in FIG. 1B, while the photomask pattern in FIG. 1C is suitable for the disposition of the apertures 104 in FIG. 1D. Referring FIG. 1E, however, the upper part of the pattern in FIG. 1E is suitable for the disposition of the apertures 102 in FIG. 1B, while the lower part of the pattern in FIG. 1E is suitable for the disposition of the apertures 104 in FIG. 1D. Therefore, in the prior art, the pattern of FIG. 1E is completed by dual exposing using two different photomasks. Namely, the upper part of the pattern in FIG. 1E is obtained by conducting an exposure using the disposition of the apertures 102 in FIG. 1B and then another exposure is conducted by using another photomask and the disposition of the apertures 104 in FIG. 1D to obtain the lower part of the pattern in FIG. 1E. Such a manufacturing method is inefficient and wasteful in production capacity.

In an actual off-axis illumination system, normally a few kinds of aperture dispositions is provided for several typical photomask patterns only. Therefore, these aperture dispositions can not meet the requirement of using only a single photomask for completing all patterns in the photomask. An exposure apparatus theoretically is able to provide an optimum off-axis illumination for all patterns of a single photomask. However, a light source intensity distribution in actual applications usually is an unchangeable one designed by a predetermined calculation and is not adapt for different area patterns of an actual single photomask. In addition, using a single light source intensity distribution has a negative impact on the process margins, such as the exposure latitude and the depth of focus (DOF). In the real practice, some problems for the controls of the light source in the off-axis illumination system still exist and need to be solved.

### SUMMARY OF THE INVENTION

Accordingly, an object of the present invention is to provide an exposure method to produce an optimum off-axis illumination for all photomask patterns.

Another object of the present invention is to provide an exposure method capable of adjusting light source intensity distributions and enhancing the process margin.

The present invention provides an exposure method suitable for an off-axis illumination system. According to the method, a photomask is provided, which includes at least a first pattern and a second pattern. Then, an analysis on the photomask is conducted for obtaining a first light source intensity distribution corresponding to a first pattern and a second light source intensity distribution corresponding to a second pattern and the analysis result is saved in a storage device. Afterwards, the light source of the off-axis illumination system is adjusted to use the first light source intensity distribution saved in the storage device for conducting exposure on the first pattern of the photomask, and the light source is adjusted to use the second light source intensity distribution for conducting exposure on the second pattern of the photomask.

In an embodiment, the above-described first light source intensity distribution and second light source intensity distribution are functions of the pattern data of the above-described photomask, wherein the pattern data of the photomask is, for example, a file in GDS (global distribution system) format.

In an embodiment, the above-described first light source intensity distribution and second light source intensity distribution are, for example, partial coherence coefficients or data for partial coherence coefficients.

In an embodiment, the steps of the above-described analysis on a photomask for obtaining the first light source intensity distribution corresponding to the first pattern are as follows. First, a plurality of light beams from the light source of the off-axis illumination system is provided and by using the beams a plurality of first images on a wafer region is formed after the beams travel through the first pattern of the photomask. Next, the first images are received by a sensor and converted into a plurality of first exposure functions. Finally, a part of the above-described light beams is selected according to the first exposure functions of the photomask and the corresponding first light source intensity distribution is obtained.

In another embodiment, the steps of the above-described analysis on a photomask for obtaining the first light source intensity distribution corresponding to the first pattern are as follows. First, a plurality of light beams from the light source of the off-axis illumination system is provided and the first pattern data of the photomask is provided as well. Next, a plurality of first images corresponding to each light beam is obtained by means of a simulation calculation. Afterwards, the first images of the photomask are converted into a plurality of first exposure functions. Finally, a part of the above-described light beams is selected according to the first exposure functions of the photomask and the corresponding first light source intensity distribution is obtained.

In an embodiment, the above-described first exposure function is, for example, a set of normalized image log slopes (NILSs) on the wafer region, or data for obtaining normalized image log slopes (NILSs), or a set of the image contrasts on the wafer region.

In an embodiment, the steps of the above-described analysis on a photomask for obtaining the second light source intensity distribution corresponding to the second pattern are as follows. First, a plurality of light beams from the light source of the off-axis illumination system is provided and by using the beams a plurality of second images on a wafer region is formed after the beams travel through the second pattern of the photomask. Next, the second images are received by a sensor and converted into a plurality of second exposure functions. Finally, a part of the above-described light beams is selected according to the second exposure functions of the photomask and the corresponding second light source intensity distribution is obtained.

In another embodiment, the steps of the above-described analysis on a photomask for obtaining the second light source intensity distribution corresponding to the second pattern are as follows. First, a plurality of light beams from the light source of the off-axis illumination system is provided and the second pattern data of the photomask is provided as well. Next, a plurality of second images corresponding to each light beam is obtained by means of a simulation calculation. Afterwards, the second images of the photomask are converted into a plurality of second exposure functions. Finally, a part of the above-described light beams is selected according to the second exposure functions of the photomask and the corresponding second light source intensity distribution is obtained.

In an embodiment, the above-described second exposure function is, for example, a set of normalized image log slopes (NILSs) on the wafer region, or data for obtaining normalized image log slopes (NILSs), or a set of image contrasts on the wafer region.

According to the present invention, the preferable light source intensity distributions of all photomasks or all photomask pattern data are obtained first. During the following exposure process, by changing the light source in real-time, a preferable light source intensity distribution corresponding to each pattern is generated. The method is applicable to a wafer exposure process used in mass production, and largely enhances the production yield, reduces rework and saves costs.

The present invention further provides an off-axis illumination system, which includes a storage device and a light source. The storage device can store a plurality of area pattern data of a photomask, a plurality of light source intensity distributions corresponding to the area patterns, a plurality of image data of the images formed on the wafer region and a plurality of corresponding relation data of the above-mentioned data. According to the stored data and the corresponding relation data, the light source intensity distribution of the light source is changed for providing proper light beams when using a single photomask for exposure.

In an embodiment, the above-described light source intensity distribution is, for example, partial coherence coefficients or data for obtaining partial coherence coefficients.

In an embodiment, the above-described off-axis illumination system further includes a sensor disposed on the wafer region. The sensor receives the images formed on the wafer region as the light beam provided by the light source passes through the photomask. According to the images, the normalized image log slopes (NILSs) or a set of the image contrasts on the wafer region is calculated for adjusting the light source intensity distribution of the light source.

The off-axis illumination system of the present invention includes a storage device for storing data, including photomask patterns and light source intensity distributions, so that the light source intensity distribution of the light source is adjustable according to the photomask pattern. The off-axis illumination system further includes a sensor for receiving images, so that the light source intensity distribution of the light source is adjustable according to received images In this way, the light source is controlled based on automatic control system, thus enhancing the resolution, the exposure latitude (EL) and the depth of focus (DOF).

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A, FIG. 1C and FIG. 1E are schematic views of photomask patterns.

FIG. 1B, FIG. 1D and FIG. 2B are display views for aperture dispositions of an off-axis illumination system.

FIG. 2A is a schematic view of an off-axis illumination system according to an embodiment of the present invention.

FIG. 2C is a flowchart showing the steps for obtaining a preferable light source intensity distribution of all photomask pattern data.

FIG. 2D is a display view showing a source map of the light source 202 in FIG. 2A.

FIG. 2E is the preferable light source intensity distribution d3 of the light source 202 corresponding to the photomask pattern in FIG. 1C.

### DESCRIPTION OF THE EMBODIMENTS

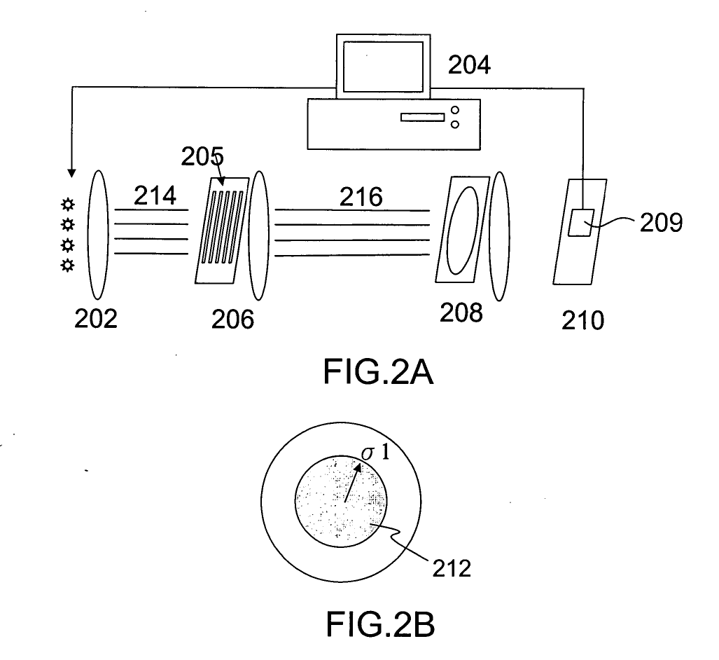

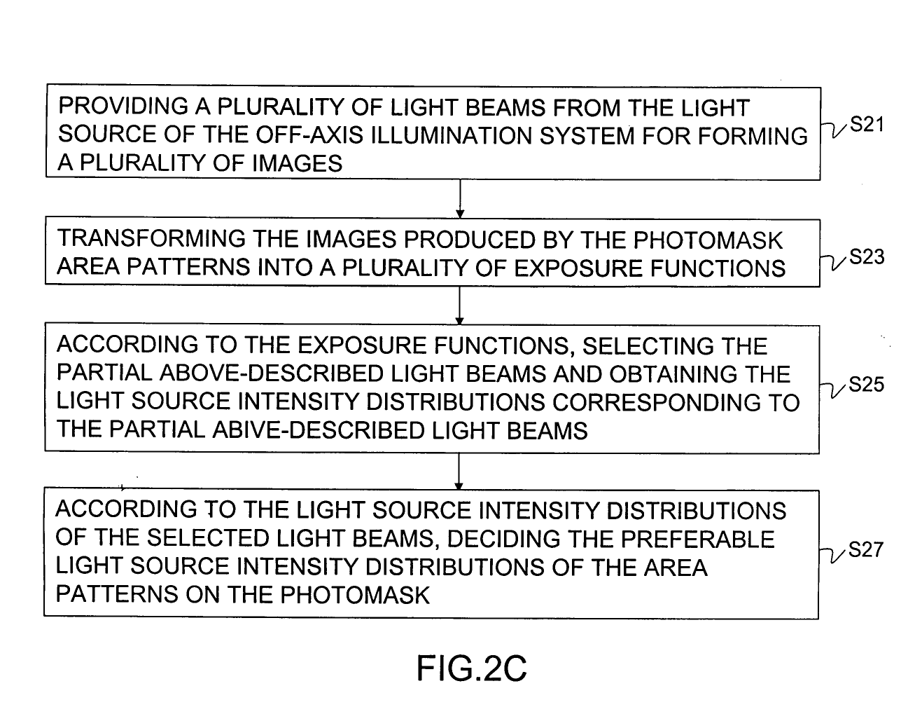

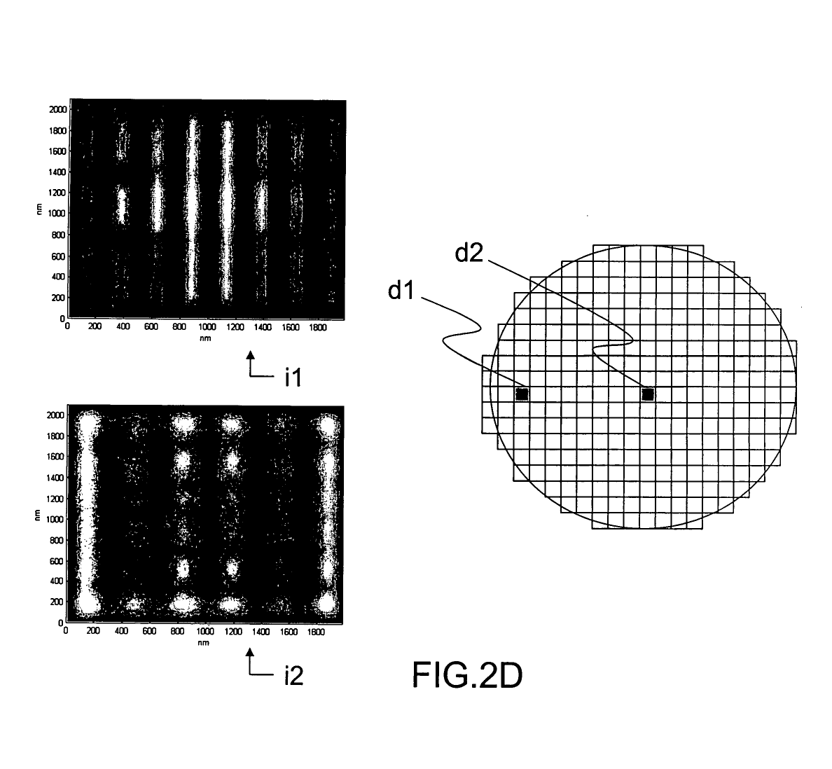

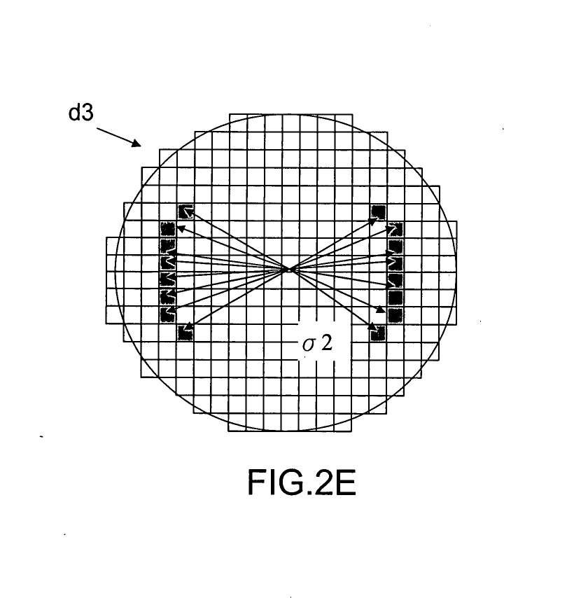

FIG. 2A is a schematic view of an off-axis illumination system in an embodiment of the present invention. In FIG. 2A, instead of a light source 202 and a storage device 204 of the off-axis illumination system, several components of an exposure apparatus, such as a photomask region 206, a pupil 208, a sensor 209 and a wafer region 210 are shown.

Referring to FIG. 2A, the storage device 204 is, for example, for storing photomask-related data, such as photomask pattern data, light source intensity distribution data corresponding to each photomask pattern, data of image formed on the wafer region 210 and corresponding relation data of the above-mentioned data. Thus, during an exposure process, the light source intensity distribution of the light source 202 can be changed to provide a proper light beam according to the used photomask, the data stored in the storage device 204 and the corresponding relation data. The photomask region 206 is, for example, the location to install the photomask for exposure. The pupil 208 is, for example, for filtering high-order diffraction component of the light beam passing through the photomask. The wafer region 210 is, for example, the location to install the wafer. The sensor 209 on the wafer region 210 detects the images formed on the wafer region after the light beams provided by the light source passing through the photomask. The storage device 204 is coupled with the sensor 209.

The light source 202 is able to provide light beams with more than one kind of light source intensity distributions. So-called “light source intensity distribution” depicts the layout of sub-sources on a light source and the light source intensities of the corresponding positions. In an off-axis illumination system, a light source intensity distribution is presented by, for example, partial coherence coefficients or data suitable for producing partial coherence coefficients. FIG. 2B is a display view showing an aperture disposition of an off-axis illumination system. Herein, to change the light source intensity distribution of the exposure apparatus, it can be simplified as changing the representing parameter, namely, the radius σ1 of the aperture 212. Once the radius σ1 is changed, the partial coherence coefficients of the exposure apparatus are varied. Further, a change of light source intensity distribution affects the diffraction angle distribution in the pupil 208 of the exposure apparatus and the exposure dose distribution on the wafer region, which further affects the resolution, the depth of focus (DOF) and the exposure latitude (EL). Therefore, according to the exposure method of the present invention, the light source intensity distribution of the light source 202 can be changed according to different patterns on a photomask and a preferable light source intensity distribution is provided in real-time for exposing, so that the desired resolution, depth of focus (DOF) and exposure latitude (EL) are obtained. In addition, the present invention does not limit to use different aperture layouts for changing the light source intensity distribution. In fact, except for a single point light source, the light source can be, for example, a dipole light source, a quadruple light source or a ringed light source.

In the following, a preferred embodiment of the exposure method of the present invention is described.

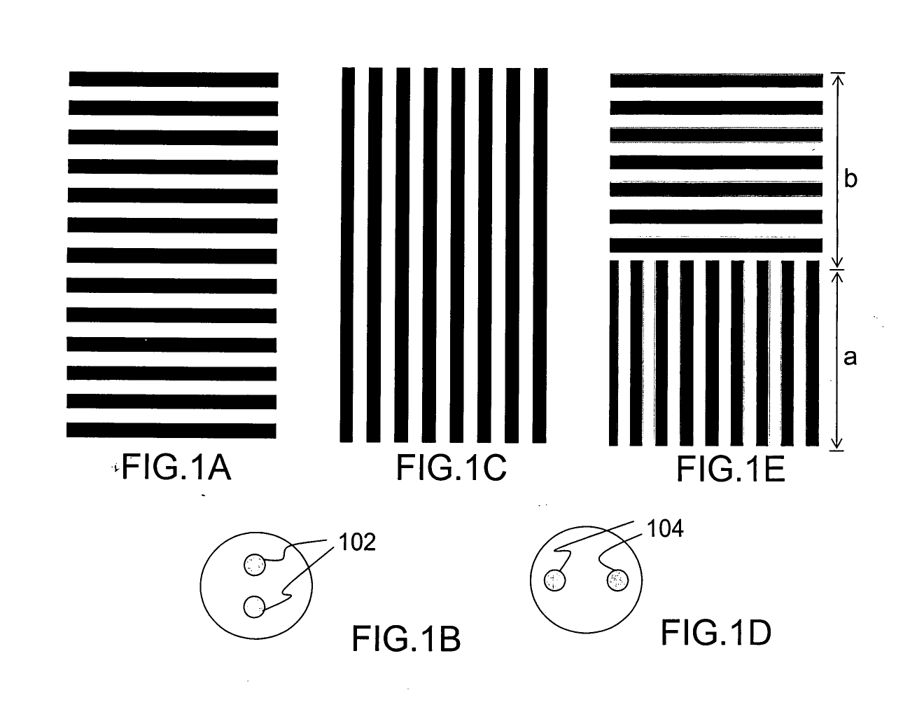

First, a photomask 205 is provided and the data of preferable light source intensity distributions corresponding to all area patterns on the photomask 205 are obtained. As exemplary, the photomask 205 is, for example, a photomask having the patterns shown in FIG. 1E and the photomask 205 includes at least a first pattern area a and a second pattern area b. By an analysis on the photomask 205, a first light source intensity distribution corresponding to the first pattern area a and a second light source intensity distribution corresponding to the second pattern area b are obtained. Next, the method to obtain the preferable light source intensity distributions corresponding to all area patterns on the photomask is described.

FIG. 2C is a flowchart showing the steps for obtaining a preferable light source intensity distribution of the photomask pattern data. FIG. 2D is a display view showing a source map of the light source 202 in FIG. 2A, wherein the light source 202 is divided into a plurality of grid areas for producing light beams and the plurality of grid areas can be counted as sub-sources.

Referring to FIG. 2C, first at step S21, a plurality of first images is formed by light beams, wherein the light beams are generated by a plurality of light beam grid areas provided by the light source 202 and the light beams pass though an area pattern on the photomask 205 (for example, the first pattern area a). As shown in FIG. 2D, an image i1 is formed by a light beam, wherein the light beam is generated by a light beam grid area d1 provided by the light source 202 and the light beam passes though the first pattern area a of the photomask in FIG. 1E. Another image i2 is formed by another light beam, wherein the light beam is generated by a light beam grid area d2 provided by the light source 202 and the light beam passes though the first pattern area a of the same photomask. The images can be obtained by, for example, a sensor capturing at the wafer region 210 in FIG. 2A or a theoretical calculation. “Image” is, for example, a function of the exposure intensity on the wafer region 210 vs the exposure positions. Taking FIG. 2D as exemplary, for different grid area positions in a source map, the corresponding light source intensity distributions are different and the subsequently formed images have different resolutions and exposure intensity distributions. In the present embodiment, the values of the exposure intensity are obtained, for example, by a theoretical calculation and the differences in the exposure intensity are distinguished by the gray-levels in the images i1 and i2.

Afterwards, at step S23, each first pattern image of the photomask 205 is sensed and received by a sensor (not shown) at the wafer region 210 or is generated by a simulation calculation using a processor. The received or calculated images are then converted into a plurality of exposure functions. In the simulation calculation using a processor, the converting method, for example, is as follows. For a given pattern data of a known photomask, the photomask pattern data is, for example, a photomask layout function G(x,y), represented by equation (1):
G(x,y)=1 if it is light-transparent at the position
or G(x,y)=0 if it is light-opaque at the position (1)
where, x, y are position coordinates of the photomask. Afterwards, a Fourier transform is conducted to the above-described function G(x,y) and an equation is obtained: g(fₓ, f_{y})=F{G(x, y)}. Then, an exposure intensity I(x′,y′,α,β) is calculated according to equation (2), and the exposure intensity I(x′,y′,α,β) is defined as the exposure intensity generated at a position (x′,y′) of the wafer region by a position (α,β) of the light source.

$$I ( {x}^{′} , {y}^{′} , α , β ) = {\vert {F}^{- 1} \{ g \begin{matrix}( \frac{{f}_{x} λ}{NA} , \frac{{f}_{y} λ}{NA} ) \\ k ( α + \frac{{f}_{x} λ}{NA} , β + \frac{{f}_{y} λ}{NA} )\end{matrix} \} \vert}^{2} \qquad ( 2 )$$

where, NA is numerical aperture, λ is wavelength of the light source and k(x,y) is pupil function defined by equation (3).

$$k ( x , y ) \{ \begin{matrix}= 1 & when \sqrt{{x}^{2} + {y}^{2}} \leq 1 \\ = 0 & when \sqrt{{x}^{2} + {y}^{2}} > 1\end{matrix} \qquad ( 3 )$$

As the images are captured by a sensor, the exposure intensity is measured. Further, the exposure intensities produced by all different light beam grid areas are converted into a plurality of first exposure functions. “first exposure function” is, for example, normalized image log slope (NILS) or data suitable for forming the normalized image log slope (NILS) of the wafer region or the image contrasts on the wafer region.

Further, at step S25, according to the exposure functions, some preferable light beams are selected from different grid areas and the corresponding light source intensity distributions are obtained as well. For example, a light beam capable of generating a larger normalized image log slope (NILS) or a larger image contrast is preferred for enhancing exposure latitude (EL). At step S25, selecting a part of light beams according to the first exposure functions is important to recognize which light beams of the light source 202 are better to provide a light source intensity distribution.

Furthermore at step S27, according to the light source intensity distributions of each selected light beam, a preferable light source intensity distribution of an area pattern on the photomask is decided. When the light source intensity distributions of the selected light beams are partial coherence coefficient, then for example, a sum operation is used and the above-described preferable light source intensity is a sum of the partial coherence coefficients of all the selected light beams. As exemplary referring to FIG. 2E, a set of gray grid areas is marked in FIG. 2E, which is a preferable light source intensity distribution d3 of the light source 202 corresponding to the first pattern area a of the photomask in FIG. 1E. It is obviously that the preferable light source intensity distribution d3 is a sum result from the light source intensity distributions of a plurality of grid areas. The light source intensity distributions of the light source 202 correspondingly have a plurality of different radiuses σ2. At step S27, the first light source intensity distribution corresponding to the first pattern area a is obtained.

Moreover, a second light source intensity distribution corresponding to the second pattern area b is obtained by repeating the above-described analysis steps from S21 to S27. Such steps S21-S27 are repeated until all preferable light source intensity distributions corresponding to all area patterns on the photomask 205 are obtained. Then, all obtained analysis results, including pattern data of all areas on the photomask 205 and the preferable light source intensity distributions corresponding to all area pattern data are stored in the storage device 204. Wherein, each preferable light source intensity distribution is, for example, a function of the pattern area data of the photomask 205, while the pattern area data of the photomask 205 is, for example, a file in GDS format.

Referring to FIG. 2A, when a wafer exposure process is conducted by using the photomask 205, the first light source intensity distribution stored in the storage device 204 is used to conduct an exposure to the first pattern area a of the photomask 205. Using the same photomask but changing the light source 202 of the off-axis illumination system, the second light source intensity distribution stored in the storage device 204 is used to conduct an exposure to the second pattern area b of the photomask 205. In other words, when the photomask 205 is used to conduct a wafer exposure process, the exposure sequence in the step-and-scan mode is, for example, conducting an exposure to the first pattern area a of the photomask 205 first, followed by conducting an exposure to the second pattern area b. Therefore, to conduct an exposure to the first pattern area a of the photomask 205, the light source 202 is controlled according to the preferable light source intensity distribution d3 corresponding to the first pattern area a of the photomask 205 and stored in the storage device 204, so that the light source 202 provides a light beam 214 according to the preferable light source intensity distribution d3. While to conduct an exposure to the second pattern area b of the photomask 205, the light source 202 is controlled according to the second pattern area b of the photomask 205 and the corresponding preferable light source intensity distribution stored in the storage device 204, so that the light source 202 provides a light beam 214 according to a light source intensity distribution suitable for the second pattern area b of the photomask 205. In this way, by changing the light source, a proper light source intensity distribution is used to conduct an exposure to the different patterns on the photomask, thus enhancing the pattern resolution and the depth of focus (DOF) of all areas on the photomask. Of course, the patterns of the photomask do not limit to the two-part patterns described above. In fact, a photomask can have more than two patterns, wherein an analysis on each area pattern on the same photomask is conducted for obtaining preferable light source intensity distributions corresponding to each pattern and the analysis result is stored in the storage device 204. To conduct an exposure, the preferable light source intensity distribution corresponding to each area pattern is loaded from the storage device 204 and the light source intensity distribution of the light source is changed according to different area patterns.

The territories of the area patterns in the present invention are categorized according to, for example, the pattern layout density and the pattern shape. For example, for a DRAM (dynamic random access memory), the areas can be simply categorized into a peripheral circuit area and a memory array area.

According to the present invention, the preferable light source intensity distributions of all photomasks or all photomask pattern data are obtained first. During the following exposure process, by changing the light source according to each area pattern, a preferable light source intensity distributions corresponding to the pattern is used to conduct an exposure. The method is applicable to a wafer exposure process used in mass production, and largely enhances the production yields, reduces rework and saves costs.

In summary, the off-axis illumination system of the present invention employs a storage device and adjusts the light source intensity distributions according to the photomask area patterns, so that the light source can be automatically controlled and preferable light source intensity distributions corresponding to the photomask patterns are used to conduct en exposure.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An exposure method, suitable for an off-axis illumination system; the exposure method comprising:
providing a photomask, comprising at least a first pattern and a second pattern;
conducting an analysis to the photomask for obtaining a first light source intensity distribution corresponding to the first pattern and a second light source intensity distribution corresponding to the second pattern and storing an analysis result in a storage device of the off-axis illumination system; and
conducting an exposure on the first and second patterns of the photomask by using a light source of the off-axis illumination system, wherein the light source is adjusted to have the first light source intensity distribution stored in the storage device for the exposure on the first pattern of the photomask and the light source is adjusted to have the second light source intensity distribution stored in the storage device for the exposure on the second pattern of the photomask.

2. The exposure method as recited in claim 1, wherein the first light source intensity distribution and the second light source intensity distribution are functions of photomask pattern data and the photomask pattern data comprises files in a global distribution system (GDS) format.

3. The exposure method as recited in claim 1, wherein the first light source intensity distribution and the second light source intensity distribution comprise partial coherence coefficients or data suitable for obtaining partial coherence coefficients.

4. The exposure method as recited in claim 1, wherein the step of conducting the analysis to the photomask for obtaining the first light source intensity distribution corresponding to the first pattern comprises:
providing a plurality of light beams from the light source of the off-axis illumination system and forming a plurality of first images on a wafer region after the light beams passing through the first pattern of the photomask;
using a sensor to receive the first images and convert the received first images into a plurality of first exposure functions; and
selecting a part of the light beams according to the first exposure functions of the photomask and obtaining the corresponding first light source intensity distribution.

5. The exposure method as recited in claim 4, wherein the first exposure functions are normalized image log slopes (NILSs) on the wafer region, data for obtaining the normalized image log slopes (NILSs), or image contrasts on the wafer region.

6. The exposure method as recited in claim 1, wherein the step of conducting the analysis to the photomask for obtaining the second light source intensity distribution corresponding to the second pattern comprises:
providing a plurality of light beams from the light source of the off-axis illumination system and forming a plurality of second images on a wafer region after the light beams passing through the second pattern of the photomask;
using a sensor to receive the second images and convert the received second images into a plurality of second exposure functions; and
selecting a part of the light beams according to the second exposure functions of the photomask and obtaining the corresponding second light source intensity distribution.

7. The exposure method as recited in claim 6, wherein the second exposure functions are normalized image log slopes (NILSs) on the wafer region, data for obtaining the normalized image log slopes (NILSs), or image contrasts on the wafer region.

8. The exposure method as recited in claim 1, wherein the step of conducting the analysis to the photomask for obtaining the first light source intensity distribution corresponding to the first pattern comprises:
providing a plurality of light beam data of the light source and a first pattern data of the photomask;
simulating and calculating a plurality of first images corresponding to the light beams according to the light beam data and the first pattern data;
converting the first images into a plurality of exposure functions; and
selecting a part of the light beams according to the first exposure functions of the photomask and obtaining the corresponding first light source intensity distribution.

9. The exposure method as recited in claim 8, wherein the first exposure functions are normalized image log slopes (NILSs) on the wafer region, data for obtaining the normalized image log slopes (NILSs), or image contrasts on the wafer region.

10. The exposure method as recited in claim 1, wherein the step of conducting the analysis to the photomask for obtaining the second light source intensity distribution corresponding to the second pattern comprises:
providing a plurality of light beam data of the light source and a second pattern data of the photomask;
simulating and calculating a plurality of second images corresponding to the light beams according to the light beam data and the second pattern data;
converting the second images into a plurality of exposure functions; and
selecting a part of the light beams according to the second exposure functions of the photomask and obtaining the corresponding second light source intensity distribution.

11. The exposure method as recited in claim 10, wherein the second exposure functions are normalized image log slopes (NILSs) on the wafer region, data for obtaining the normalized image log slopes (NILSs), or image contrasts on the wafer region.

12. An off-axis illumination system, comprising:
a storage device for storing a plurality of area pattern data corresponding to area patterns of a photomask, a plurality of light source intensity distribution data corresponding to the area patterns, a plurality of image data corresponding to images produced on a wafer region and a plurality of corresponding relation data of the area pattern data, the light source intensity distribution data and the image data; and
a light source, wherein a light source intensity distribution of the light source is adjustable according to the area pattern data, the light source intensity distribution data and the image data and the corresponding relation data stored in the storage device to provide light beams for the photomask to conduct exposure.

13. The off-axis illumination system as recited in claim 12, the light source intensity distribution comprises partial coherence coefficients or data suitable for obtaining partial coherence coefficients.

14. The off-axis illumination system as recited in claim 12, further comprising a sensor on the wafer region for receiving the images, wherein the images are formed on the wafer region after the light beams provided by the light source passing through the photomask.

15. The off-axis illumination system as recited in claim 14, wherein normalized image log slopes (NILSs) or image contrasts on the wafer region are determined according to the images for adjusting the light source intensity distribution of the light source.
